(19) United States
(12) Patent Application Publication
(10) Pub. No.: US 2015/0220961 A1
(43) Pub. Date: Aug. 6, 2015

(54) METHOD, SYSTEM AND TOOL FOR FACILITATING FINANCIAL TRANSACTIONS

(71) Applicant: CONNECTALEX IP PTY LTD, Sydney (AU)

(72) Inventors: Leighton Jenkins, Sydney (AU); Monojit Andrew Ray, Roseville (AU)

(21) Appl. No.: 14/684,526

(22) Filed: Apr. 13, 2015

Related U.S. Application Data
(63) Continuation of application No. PCT/AU2013/001180, filed on Oct. 11, 2013.

(30) Foreign Application Priority Data
Oct. 12, 2012 (AU) 2012904464

(51) Int. Cl. G06Q 30/02

(52) U.S. Cl. CPC G06Q 30/0229; G06Q 30/0255; G06Q 30/0269; G06Q 30/0276

(57) ABSTRACT

A method, system and tool for facilitating financial transactions is presented to enable intermediaries to connect a plurality of large institutions to help those institutions to precisely target their potential customers via an intermediary device. which aids the efficiency and effectiveness of participant organisations to cross-promote their products.

### CROSS REFERENCE TO RELATED APPLICATIONS

This application is a continuation of PCT/AU2013/001180, filed Oct. 11, 2013, which claims priority to Australian Patent Application No. AU2012904464, filed Oct. 12, 2012, the contents of each of which are incorporated by reference herein.

### TECHNICAL FIELD

The present invention relates to the implementation of interfaces between financial and telecommunication services.

### COPYRIGHT NOTICE

This document is subject to copyright. The reproduction, communication and distribution of this document is not permitted without prior consent from the copyright owner, other than as permitted under section 226 of the Patents Act 1990.

### BACKGROUND

The use of intermediaries to connect a plurality of large institutions is important to help those institutions to precisely target their potential customers. Such customer targeting is often made by offers presented via an inter-organisational intermediary, since such an intermediary aids the efficiency and effectiveness of participant organisations to cross-promote their products.

Examples of such intermediaries are loyalty schemes including frequently flyer promotions. Other mechanisms of using intermediaries include the use of prepay cards, which are often employed across organisations to improve loyalty and efficiency, so as to aid organisational growth.

Such loyalty schemes, however, have come at a relatively high cost for the organisations involved, since discounting is mandatory for participant organisations, and customers expect such discount offers to be standard. When an offer becomes standard, then the offer's emotional impact is lost and the potential customer is not compelled to purchase, since the offer is perceived as a mere standard deal.

Offers that have an initial impact but relatively poor adherence include frequent flyer rewards, supermarket-fuel cross promotion and even bundling software with computer hardware, which has become standard practice.

Such standard practices lack flexibility and dynamic bundling so that there are very few inducements for consumers to move from one cross promotion to another. That is, loyalty schemes do not appear to be differentiated from each other.

Consequently, once a customer base is locked into a loyalty allegiance, then there is no movement.

In this scenario if, for example, competing firms offer a promotional scheme, such that a customer allegiance is determined and fixed early on in the relationship, then there is no subsequent benefit to either organisation offering such a cross-promotional deal.

For further example, once customers are locked into a supermarket-fuel cross promotion allegiance, then subsequent sales are not attracting more customers into the allegiance. This results in a zero sum game in terms of benefit, since after the expenditure with regard to the opportunity cost and the ongoing expenditure with discounting of fuel (and all like discounts), there is no greater allegiance by the customer to the offerees.

The reasons why such cross-promotional opportunities often do not permeate beyond the point of sale is that there is limited ongoing allegiance, which can be problematic because loyalty schemes rely on:
(a) perceived ongoing benefit, or a reward which may not be of primary interest to the customer and therefore loyalty wanes. For example, many of the credit card loyalty schemes required expenditure of hundreds of thousands of dollars before a local domestic airplane trip was obtained. Thus, the perceived pleasure of a potential trip decreases over time since the benefit is not proximal to the user's current lifestyle; or
(b) continued loyalty involves purchasing via use of a secondary card, such as frequent flyer card. Often enrolments into such systems involve sending out the card at the expense of an organisation. The behaviour of the recipient on receipt of such a card is that they were unlikely to carry it, let alone use it over the many years required to return the benefit, since the barrage of such card schemes meant that customers had to carry wallets of cards without any ongoing inducement to use such cards. Consequently, continued loyalty is lost.

The outcome of the above approaches give little ongoing benefit to the participant organisations involved, along with limited perceived value to the customer due to the appropriateness or lack of distinction of the rewards presented.

A further problem exists when a targeted customer's needs are short term or only required on an ad hoc basis, then the benefit returned to the member organisation can be marginal at best Thus, when the opportunity cost is great, with the benefit back to the member organisation being too short, so that the opportunity cost is high and difficult to justify within large organisations.

These limitations need to be overcome by allowing a more flexible and dynamic mechanism to be implemented to enable consumers to have access to opportunities by two or more like sized organisations, without permanently increasing operational costs in each organisation.

Typically, an intermediary is an external organisation that is used because most large organisations do not have the required objective independence to identify inter-organisational offerings that will be potentially attractive to consumers.

Likewise, the intermediary organisation can be more flexible and dynamic (but these advantages also may also come at a cost), since they can objectively view and monitor opportunities across organisations, rather than within. Consequently, opportunities that potentially form a disruptive opportunity in the market are less likely to be missed when intermediary organisations are involved.

To date, there has been a partial easing of the above obstacles with the rise of the “virtual financing”. This has increased the availability for, and desire by, organisations to engage specialist cross promotions between like sized organisations, such that it provides a valuable perceived benefit to the customer. However, “virtual financing” has not fully provided a solution to overcome many of the problems involved in inter-organisational cross-promotion.

Loyalty to organisations can be improved if organisations can meld their combined delivery of goods and services in an agile manner to respond to the changing fashion of perceived needs. Examples include the need to capture an opportunity, implement a cross-promotion strategy and/or to provide a perceived benefit.

A difficulty faced by many organisations is that they lack agility, particularly between organisations of significant size because they are often constrained by the lack of interfaces available for inter-organisational offers, or by connections that are made via an intermediary organisation, which may mean that an organisation's sensitive data may fall into a third party's hands or out of the control of the contributing organisation.

It is an object of the present invention to provide a method for providing an inter-organisational interface that is able to meet at least one of the above means or to provide a suitable alternative.

### SUMMARY

According to one aspect of the invention there is provided a method for implementing an inter-organisational interface including the steps of:
(a) connecting participating organisation's offerings to identify and offer customers anticipated need by bundling of goods and/or services of each participant organisation as a synergistic market offering;
(b) selecting ongoing opportunities with participant customers to address one or more identified customer need through use of an algorithm, wherein the algorithm analyses previous customer purchases.

According to another aspect of the invention there is provided a method for implementing an inter-organisational interface including the steps of:
(a) mediating financial transactions between participant organisations by enabling participant organisation to synergistically provide benefits to participating customers by:
   i. generating cross/inter-organisational offers; and
   ii. selecting customers with specific purchasing profiles to receive these offers.

Preferably, the inter-organisational offering includes the substep of generating new offers to supplement existing offers to complement a customer need.

More preferably, the inter-organisational offering process includes the following sub-steps:
(a) one or more goods and/or service offerings are made to participant customers once a threshold is crossed, or criterion is met, as determined by an actuarially based algorithm that refines, directs and recommends offers—the Refine, Direct and Recommend system (RDR):
(b) receiving an enquiry from one or more customer(s) who qualify as meeting the threshold criterion of the actuarially based algorithm that refines, directs and recommends offers, will receive a specified offer,
(c) a loyalty audit system compiling offers received from a customer, wherein the loyalty audit system comprises the enablement of delivery of one or more offers and the transaction of any offers accepted.

According to another aspect of the invention there is provided an inter-organisational interface, hereafter referred to as ConnectAlex, comprising programming instructions for facilitating identification of one or more customers perceived or required needs, wherein the programming instructions enable:
(a) capture of customer's response regarding one or more of the following:
   i. one or more organisation's existing offerings;
   ii. one or more inter-organisational generated offerings that exceed existing offerings in terms of customer loyalty and/or benefit, or reduced cost to participant organisations; and
   iii. one or more generated offerings offered to one or more customers whose profile meets the suitability threshold for such generated offerings required to meet an organisational need identified by an operational review, such that offers do not exceed the capabilities the organisation or fall outside the parameters of the business case that forms the policy identified within an organisational review;
(b) processing of said customer's response to calculate an impact on said organisation's capacity to deliver on one or more offers made in conjunction with other participant organisations;
(c) communicating said impact of said offers accepted by one or more customers across one or more organisations, wherein said impact is printable, downloadable or otherwise as generated by ConnectAlex in the form of a an inter-organisational connectivity tool, method and system.

According to yet another aspect of the invention there is provided a system for facilitating customer allegiance via the inter-organisational connectivity tool;
(a) an inter-organisational connectivity method performed by the inter-organisational connectivity tool;
(b) further steps in a method for generating an inter-organisational offer and review to identify one or more customer's real or perceived needs; and
(c) implementing an inter-organisational method for selecting relevant customers within and across participant organisations to address their identified customer needs, wherein the inter-organisational offering process dynamically adapts generated offers to meet emerging consumer needs.

The invention provides a new or alternative method, system and tool for providing an inter-organisational interface that overcomes the difficulty of current customer offers and loyalty scheme models by enabling a plurality of organisations to collectively meet one or more customer needs (hereafter including either real and/or perceived) by:
a) generating a review of one or more offer(s) made by one or more organisation(s) to identify customer real or perceived needs; and
b) selecting relevant participant customers to address identified customer's needs through an inter-organisational offering process, wherein the inter-organisational offering process dynamically generates and adapts offers to meet current and/or emerging consumer needs.

For a better understanding of the invention and to show how it may be performed, a preferred embodiment will now be described, by way of non-limiting example only, with reference to the accompanying drawings.

### BRIEF DESCRIPTION OF THE DRAWINGS

For the sake of clarity, a non-limiting example in the preferred embodiment will use organisations described as a telecommunications organisation (Telco) and a financial organisation (FinCo). However, the skilled addressee will appreciate that the above is used for exemplary purposes only and is not limited to the above organisations.

FIG. 1 is a schematic illustration showing the exemplary requirements for a customer interface to access inter-organisational offers that are made via a connection between participant organisations that incorporates an interface.

FIG. 2 is a flowchart showing the method of inter-organisational interface according to an embodiment.

FIG. 3 is a schematic block diagram showing an inter-organisational tool, method and system according to an embodiment of the invention, the tool being a computer program product embodied in a computer readable storage medium for facilitating identification of one or more generated offerings offered to one or more cost customers whose profile meets the suitability threshold for such generated offerings required.

FIG. 4 is a flowchart showing the method of adapting a generated offer so it is combined with a loyalty promotion from an associated participant organisation as performed by an embodiment of the inter-organisational tool, method and system.

FIG. 5 is a flowchart showing the inter-organisational generated offer matched a customer, whose profile meets or exceeds the threshold requirements to receive such an offer, according to an embodiment.

FIG. 6 is a schematic illustration of a billing system that is made and offered to one or more customers via an inter-organisational interface.

FIG. 7 is a schematic illustration of Money Match Process that is made and offered to one or more customers via an inter-organisational interface.

FIG. 8 is a schematic illustration of Telco Sales Distribution system with phone (e.g. SMS).

FIG. 9 is a schematic illustration of FinCo Sales Distribution system.

### DETAILED DESCRIPTION

### Definitions

Customer—The retail public at large but principally subscribers to mobile, internet telecommunications, financial services and other industries with periodic, regular or otherwise, payments.

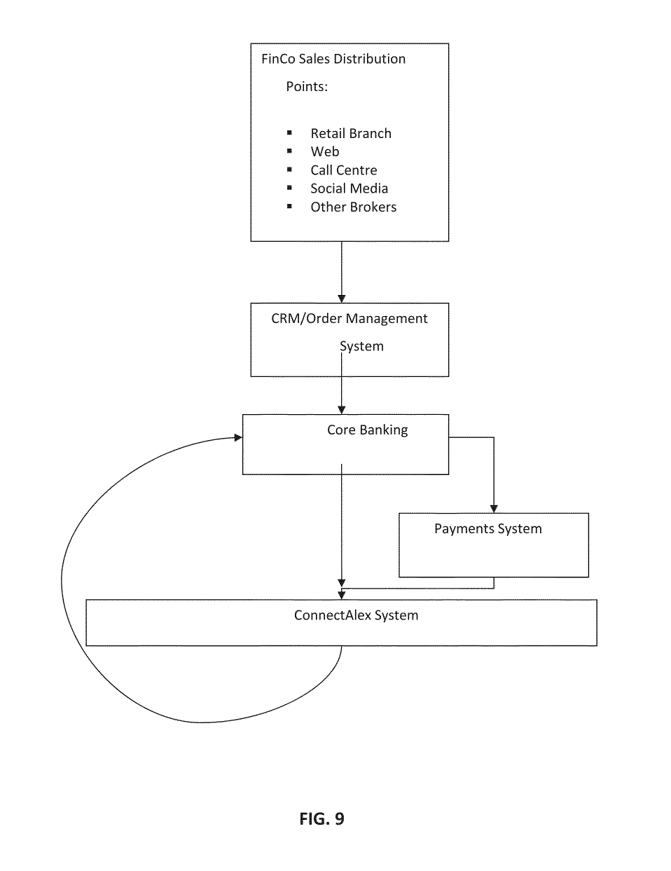

Financial Services Companies (FinCo)—such as retail banks, funds management, credit/debit card companies, customer technology providers, utilities or similar service providers. FinCo distribution channels are shown in FIG. 9.

Inter-organisational participants—the key organisations that contribute their products/services and distribution networks to implement a specific ConnectAlex device (tool), method and system. For example, the specific TelCo and FinCo entities or others involved in a ConnectAlex.

Sponsors—special purpose participants that may contribute to a specific wallet e.g. Insurance, Funds Management

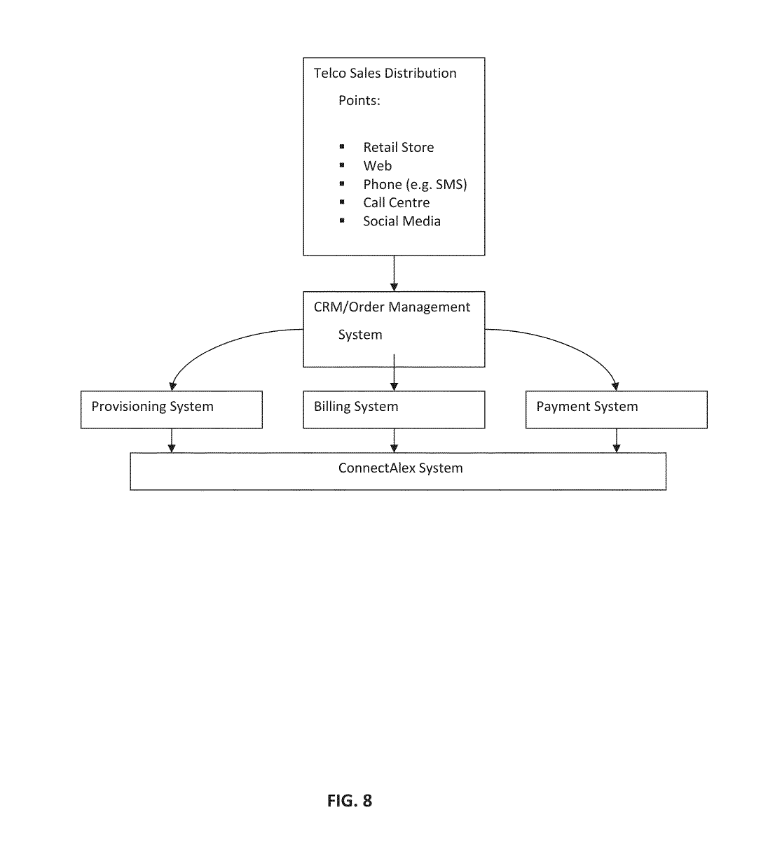

Telecommunications Providers (TelCo)—mobile, fixed line and broadband telecommunications companies and their distribution channels as shown in FIG. 8.

Organisations such as telecommunications (TelCo) and financial services organisations (FinCo) are used as the exemplary organisations, since both have large customer bases with unique distribution channels. These organisations are discussed as exemplary organisations; however, the inventors do not envisage that the invention is to be limited to such organisations.

The elements of the invention are now described under the following headings:

### Detailed Description of a Source Preferred Embodiment

The invention, termed ConnectAlex, provides a new or alternative method, system and tool for enabling an inter-organisational interface which:
a) performs a review of one or more organisation's offers across the collective customer base to identify the matching of current offers to customer's needs;
b) identifies the customer's needs that are not met by one or more organisation's offers, so that new offers are generated to meet one or more customer needs and/or to provide loyalty back to the participant organisations; and
c) selecting one or more customers with needs that are suitably matched to receive one or more additional inter-organisational generated offers, wherein the inter-organisational offering process dynamically adapts generated offers to meet emerging consumer needs.

To date, there is no method for implementing such interfaces between organisations, such as financial and telecommunications organisations, apart from relying on third party services such as loyalty schemes and prepay cards, which suffer a number of disadvantages including lack of control by participant organisations who are participating (along with other problems listed in the background above). That is, when a loyalty scheme offers discounts with all telecommunications providers, then the resultant impact is merely a price cutting war between telecommunication providers as opposed to enhanced loyalty and cross-promotional benefits.

The opportunity for organisations to improve organisational loyalty by implementing an inter-organisational interface for use on an ongoing basis to empower specific organisations to bundle and/or cross promote services is a benefit of the invention described forthwith.

The preferred embodiment provides service offerings that are compliant with:
i. market rules for interacting with participating organisations. For example, a cross promotion between telecommunication and financial organisations may present a customer, who is a customer of the specific financial organisation, with a choice to join a new telecommunications company to benefit from reduced account keeping fees (or alternative inducement); however, if the customer rejects such an offer, then this does not entitle the telecommunications company to independently make new offers to the customer, since this customer was not previously a customer of the telecommunications organisation;
ii. business unit rules for interacting with a specific business unit within participating organisations. For example, an interest rate offered by a financial institution for a particular sum of money may be added to (or subtracted from) a separate entity as enabled using the ConnectAlex interface, since the financial institution's operations must be kept independent and abide by the regulatory requirements for financial institutions; and
iii. algorithm module(s) to read previous purchasing criteria, which are used to aid the specification of future options of possible interests to the customer. This intended facilitation of creation of future option offers is to instil and/or confer customer loyalty to participant organisations by matching of customer behaviours to the service offerings.

This inter-organisation approach in using an inter-organisational interface to provide one or more offers to customers assists in addressing the need for operational efficiency between organisations in making such inter-organisational offers such as bundled offers.

### Data Exchange

ConnectAlex is enabled to:
a) connect participant organisations together;
b) integrate participant organisation's data such that data mapping protocols are implemented to enhance the dataset in a synergistic manner;
c) mine the synergistic data so as to provide customer data profiles that are suitable to have offers are matched to these profiles; and
d) recommend using an actuarially based algorithm that refines, directs and recommends offers suitable for specific customers.

These offers may exist in a form where the offered goods/services provide:
i. loyalty to one or more participant organisations;
ii. goods/services with discounts/savings to the customer; and
iii. maintaining the offers across inter-organisational policies and within each participant's organisational policies, so that there is an advantageous business case and beneficial outcome to participant organisations. This is to overcome the problem of offers being extended to customers resulting in a price cutting war, with no immediate or long term benefit back to participant organisations.

For example, a participant telecommunications organisation may benefit by decreased churn and certainty in payment; likewise, a financial services provider may benefit by into increased branding and greater co-operation and identification of its customers, along with a larger customer base. The consumer may benefit from a discount in telecommunications costs, and increase in loyalty bonuses by the financial institution and/or some other arrangement.

### Interface to Participant Organisations

ConnectAlex provides an interface, embodying information technology systems, to enhance inter-organisational business processes and proprietary business development systems for use by organisations and customers alike; however, access screens on the ConnectAlex interface will reveal information appropriate and unique to organisations, such as business metrics, which is different to the information provided to customers, such as offers, specific account information et cetera.

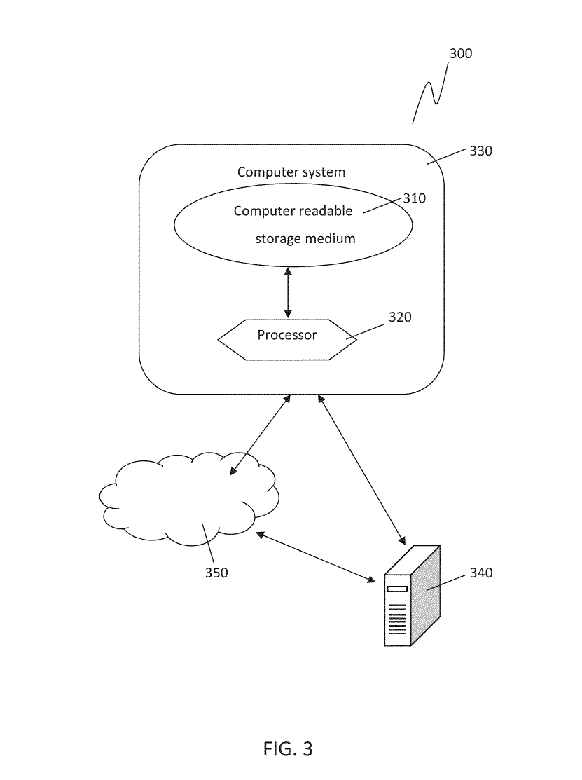

Referring to FIG. 3, the ConnectAlex tool, method and system 300 is a computer program product comprising programming instructions for an inter-organisational connectivity method. The inter-organisational tool, method and system 300 comprise software embodied in a computer readable storage medium 310. The inter-organisational connectivity method facilitates the identification of one or more generated offers presented to one or more matched customers whose profile meets the suitability threshold for such generated offers made by participant organisation.

The programming instructions of the ConnectAlex tool, method and system 300 are performed by a processing means (e.g. a processor 320 of the computer system 330). The inter-organisational ConnectAlex 300 may communicate with a server 340 or a computer network including the internet or the cloud 350, or a mobile communications network.

ConnectAlex enables a plurality of organisation to link with customers from each organisation, via a ConnectAlex interface, to collectively offer benefits to customers. For example, offers provided and bundled by participant Telco and FinCo organisations are enables to be offered to the customers of both organisations, so that the strengths of each organisations offerings is maximized.

For example, the FinCo can offer better financial rates in conjunction with better telecommunication rates offered by the TelCo, so that the offer may take the form of low telecommunication rates (provided by the TelCo) with discounted and delayed payments on telecommunication hardware (provided by the FinCo).

ConnectAlex is also enabled to receive data from these participant organisations, such as the example Telco and FinCo organisations, on a periodic basis to communicate the customer's activity, so new offers can be made via the actuarially based algorithm that refines, directs and recommends offers suitable for suitable customers.

The customer data from each participant organisation is enabled to be processed so as to provide information so as to reveal one or more customer's behaviours and needs. Customers are also enabled to be offered information through the ConnectAlex interface that educates and enables deposit to be made or purchase decisions to be transacted.

The above participant inter-organisational relationships comprise organisations that are enabled to:
a) contribute data concerning the customer user base;
b) synergistically participate to enable offers to be generated that address customer needs, aspirations and/or desires;
c) generated cost and benefit to each participant organisation from the offers involve participant organisations, so that the business metrics are clearly described to each participant organisation, who are enabled to review the business case (including the return on investment) for their involvement in such generated offers; and/or
d) benefit consumers, who use the ConnectAlex interface, so that offers across organisations are enabled to “mixed and matched” by the customer in a manner that is most desirable to meet the customer's objectives.

To date the connection and integration of large organisations such as telecommunications and financial organisations have been limited to payments systems e.g. paying a phone bill, paying a bill over the internet; or providing access to an online banking account. ConnectAlex integrates these exemplary organisations so that multiple distribution channels become available to participant organisations.

The ConnectAlex interface enables inter-organisational offers to be made, utilising the area of virtual finance by participant organisations in the financial and telecommunication services space, to specifically target customer needs and thereby improving customer loyalty.

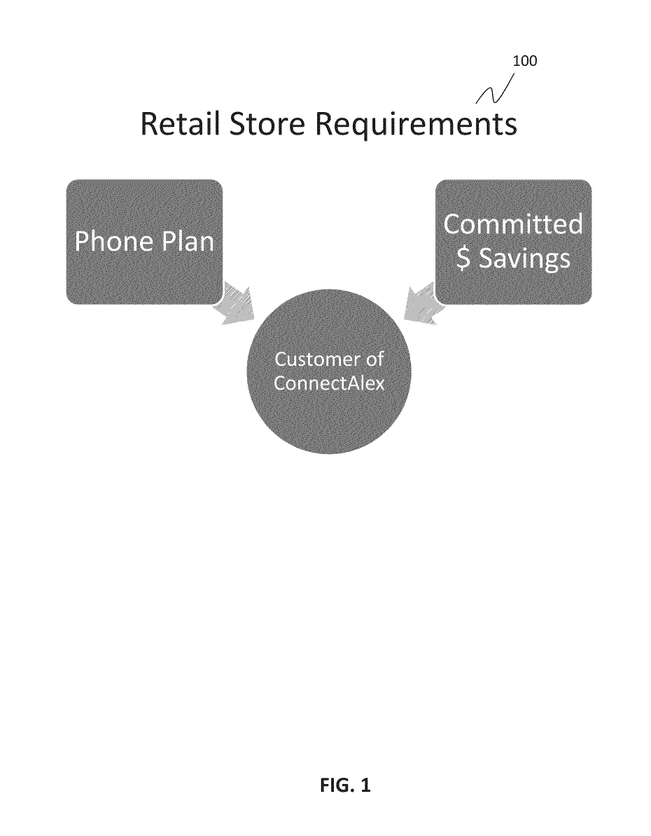

FIG. 1 is a schematic illustration of an exemplary and minimum components required to be included in a ConnectAlex customer interfaces so that inter-organisational offers are enabled to be made via the ConnectAlex 100, which is a direct data connection between participant organisations that incorporates an interface. FIG. 1 incorporates our two exemplary companies of FinCo (which handles the “committed $ savings”) and a Telco (which handles a “phone plan”). Additionally, the exchange of captured identity verifying documents is enabled so that if one organisation captures adequate documentation, this is enabled to be exchanged with participant organisations without re-verification.

For example, if a FinCo capture the 100 point identification detail, then this detail is enabled to be exchanged via ConnectAlex so as to have an account ready by a participating TelCo, without requiring the re-verification of identity documentation.

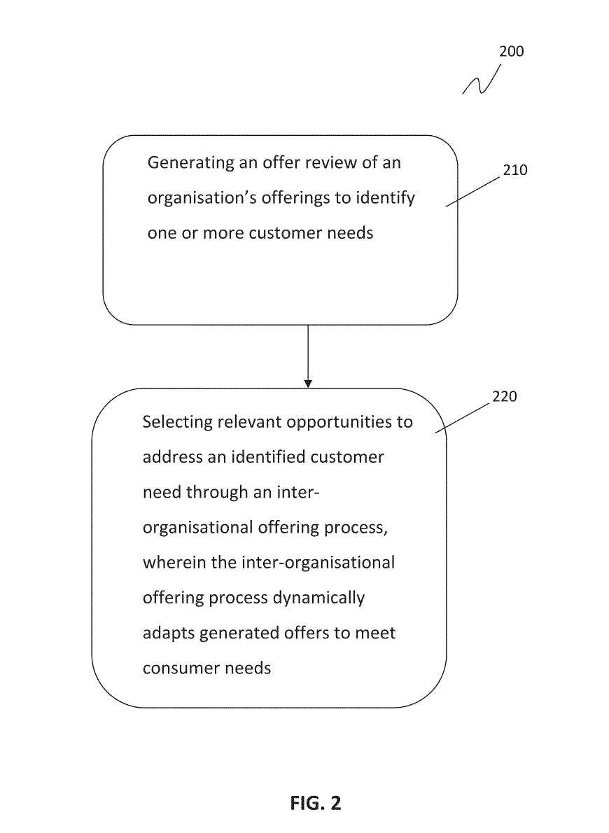

In an embodiment (see FIG. 2), the method for inter-organisational interface 200 includes the steps of:
a) generating an offer review of an organisation's offerings to identify one or more customer real or perceived needs (step 210);
b) selecting relevant opportunities to address an identified customer need through an inter-organisational offering process, wherein the inter-organisational offering process dynamically adapts generated offers to meet current or emerging consumer needs (step 220).

The advantage of generating an offer review of an organisation's offerings (step 210 of FIG. 2) is that it provides an early “data insight” to the process of obtaining the required participant organisations to fulfill a customer's needs. This is because information obtained from the customer is obtained independently from, for example, both a Telco and a FinCo, then forwarded and analysed by ConnectAlex, so that the data is taken through a rigorous and well defined process for reviewing a customer's needs.

Organisations traditionally have been unable to utilise such a “data insight” step, since they were unable to go through any independent data verification and data cleansing, or if contracting independent consultancies to perform this step there was a significant cost before achieving any possible benefits to the customer and/or participant organisations, along with the appraisal of costs of possible inducement(s) (loyalty bonuses) of making an offer to a customer.

Referring to FIG. 2, the next step in the preferred embodiment of a method of selecting relevant opportunities via the ConnectAlex interface is the step 220: This selecting of relevant opportunities is to address an identified customer need through utilising the data obtained in the earlier step of 210 where review of the inter-organisational offering process was analysed, wherein the inter-organisational offering process dynamically adapts generated offers to meet consumer needs (emerging, real or perceived).

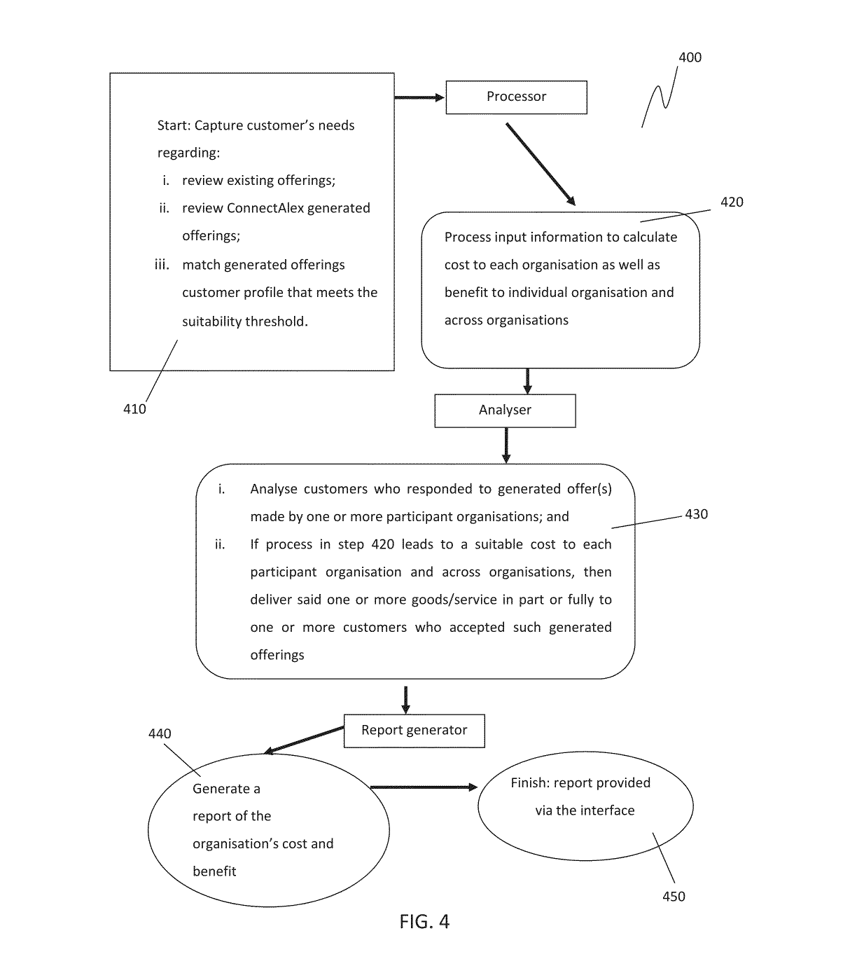

In an embodiment, the step 210 of generating an offer after review of an organisation's offerings includes the substep of generating an inter-organisational offer (see FIG. 4).

The inter-organisational offer 400 is performed by using an inter-organisational tool, method and system (see item labeled 300 in FIG. 3).

### ConnectAlex Infrastructure

ConnectAlex consist of components including:
a) communication in the form of Data Exchange: the connection between participant organisations enables the exchange and analysis of participant organisation's data so as to produce an enhanced dataset. For example, TelCo distribution networks with FinCo distribution networks have their data combined to provide an enhanced dataset for the purpose of providing profiles of customer goods/services purchasers to date and possible gaps in purchasers so that one or more offers can be matched to meet one or more customer needs;
b) transactions via one or more Digital Wallets: for the purpose of gathering deposits and payments for purchasers involving one or more offers and/or providing a deposit taking system within one or more participant organisations.
   The deposit taking system is also enabled to provide a savings means within one or more participant organisations, which are in turn, is enabled to provide loyalty, via a point to currency exchange mechanism discussed below or via another means, directly to, or via an affiliated participant organisation, that has not previously benefited from such savings means.
   For example, funds deposited via the ConnectAlex interface are enabled to obtain a beneficial interest rate from a participant financial institution as well as a cross-promotional discount or enhanced offering by a participant telecommunications organisation;
c) generation of one or more offers by a plurality of participant organisations as made, and matched specifically to, one or more customers utilising information obtained from the enhanced dataset.
   These offers are made, and generated from, ConnectAlex information technology infrastructure which provides the interface for

communications between customers, and participant organisations such as a TelCo and FinCo, so as to enable transactions to be dynamically exchanged through participant organisations and monitored and viewed through the ConnectAlex interface; and
d) process business functions to manage the ConnectAlex loyalty programme and the generation and maintenance of the FinCo and TelCo accounts when customers have met pre-specified criteria.

Referring to FIG. 4, the ConnectAlex inter-organisational offer 400 is enabled by performing tasks including the steps of:
a) capturing customer's needs regarding:
   i. one or more participant organisation's existing offerings;
   ii. one or more ConnectAlex generated offerings that exceeds existing offerings in terms of customer loyalty and/or benefit, or reduced cost to participant organisations and/or customers; and
   iii. one or more generated offerings presented to one or more customers whose profile meets the suitability threshold for such generated offerings and which meet a customer's need as identified by the RDR (refer step 410);
b) process input information to calculate cost to each organisation as well as benefit to individual organisation and across organisations (step 420);
c) analyse customers who responded to generated offer(s) made by one or more participant organisations; and
   I. if process in step 420 leads to a suitable cost to each participant organisation and across organisations,
   II. then deliver said one or more goods/service in part or fully to one or more customers who accepted such generated offerings (step 430);
d) generate a report of the goods/services offered (step 440) including a return of investment and business case to extrapolate over time the value of the current transactions;
e) communicate in the form of a report, which is printable, downloadable or otherwise accessible by a user of the ConnectAlex customers and/or participant organisations (step 450).

In an embodiment, the report includes the business case and return on investment as calculated and presented via the ConnectAlex interface as a result of the customers taking up offers and enabling transactions with participant organisations.

### Distribution Channel Enhancement

ConnectAlex in utilising distribution channels of participant organisations enhances the distribution channels of each participant's channels. For example, utilising a Telco's retail sales distribution channel, a FinCo's participant organisation's distribution channel is also enhanced. Further, the use of one or more ConnectAlex loyalty systems across participating organisations is mutually beneficial to all participant organisations.

The use of a digital wallet enables interfacing financial transactions between participant organisations and the customer. For example, a TelCo's distribution model utilising a ConnectAlex digital wallet is enabled to have inter-organisational labeling and customer detail, so as to generate a FinCo product matched to the customer profiled needs, creating a new “Go to Market” (GTM) capability for the FinCo to directly meet customer's needs.

That is, for information captured concerning a specific customer (for example, at a retail point of sale) may be utilised across participant institutions, so as to open a new offering to a participant organisation. For example, a new TelCo account can be generated when a ConnectAlex customer purchases a phone, along with the generation of a new FinCo account.

For further clarification, when the requisite details concerning a specified customer have been provided to one participant organisation, then these details are enabled to be utilised across other participant organisations—for example, when signing up for a bank account in a FinCo organisation, then such information can be also utilised to obtain a telephony account from the participatory Telco organisation.

Additionally, loyalty benefits, payment options and additional benefits are enabled to be provided across organisations. The information captured at retail point of sale will cover the data required to open a new FinCo account, a ConnectAlex account and/or a new TelCo account. This utilisation of participant organisation's distribution channels enables new “Go to Market” (GTM) channels to be established.

### ConnectAlex Dynamic Assessment and Evaluation

In a further embodiment, the data captured and analysed through the ConnectAlex tool, method and system enables an assessment and evaluation of consumer usage and trends for ConnectAlex retail customers (for both individual and aggregated usage) in order to provide feedback in real time so as to be enabled to monitor service delivery and to educate the consumer through computer enabled devices such as their mobile device. This is the Business to Consumer Education system (BECs).

BECs collect and evaluate individual or aggregate consumer data in combination with the Digital Wallet so as to enable real time feedback on how one or more customers and their accounts are performing. For example, ConnectAlex is enabled to signal advance payments in one account so as to give collective security the payments in other connected accounts. This may be signalled through various means including the allocation of bonus rewards.

The allocation of funds rewards is redeemable in dollar values so as to represent an entitlement in currency rather than virtual points. Therefore, such a reward system is transferable across various ConnectAlex accounts. ConnectAlex only provides the data of the entitlement from participant organisations on satisfaction of conditions or rules (such as market, business unit or membership rules). ConnectAlex does not hold money on trust for or deposited by/for the consumer.

### Generated Offers

ConnectAlex is enabled to parse data collected from one or more customer's purchasing behaviours and trends. This data collection and subsequent analysis provides information in the form of:
a) additional data to the enhanced dataset; and
b) feedback to each member organisation.

This information is enabled to be used individually or collectively (with other participant organisations) via ConnectAlex to target offerings or services to current or potential customers. This generation and targeting of offerings includes the incorporation of an actuarially based algorithm that refines, directs and recommends outputs via the RDR system.

The RDR is a unique actuarially designed algorithm is enabled within the ConnectAlex interface that evaluates participant organisations offers against consumer behaviour. An RDR is used in conjunction with the Digital Wallet and provides directed feedback to the participant organisations.

### Connection Capability Enablement Via ConnectAlex Information Technology

The ConnectAlex Information Technology Systems allows devices that do not otherwise communicate easily, to use ConnectAlex as an external repository and data feed to connect, process and process each consumer's data and associated information through a product lifecycle.

Connections developed between participating organisations such as our exemplary TelCo and FinCo are enabled to be setup in parallel, to run in different geographies, and/or include different participants in one or more programs. Each separate ConnectAlex system and programme is called an ‘instance’.

ConnectAlex is enabled to link participant organisations data transfers via data mapping protocols, so that approved data can be dynamically exchanged. For example, the data exchanges will be initially connected via a ConnectAlex data porting interface, followed by dynamic exchange so that each participant organisation's contribution can be monitored. That is, there is two key phases contributing to the connections between participant organisations and/or customers consisting of:
a) Initial setup; and
b) On-going contribution monitoring.

For example, during setup, participant organisations will be enabled to be linked to ConnectAlex systems by the inclusion to each participant organisation of an:
a) Operational Support Systems (OSS); and
b) Business Support Systems (BSS) were business processes are enabled to:
   I. manage the ConnectAlex loyalty programme; and
   II. setup participant organisation's accounts for consumers who have met certain threshold criteria to be suitable for such accounts.

In one embodiment, the provisioning and billing systems and their components are included in the Operational Support Systems.

Additional core elements that are enabled to be included in this embodiment are:
a) Setup of ConnectAlex digital wallet;
b) Commitment to the ConnectAlex programme;
c) verification of data exchanged so that appropriate data cleansing takes place. For example, where proof of identity has been substantiated by two independent member organisations, such verification must be reconciled. Alternatively, the capturing of further proofs of identity may be required. Likewise, for new customers proof of identity is enabled to be captured as required by authorities within each geography; and
d) Legal acceptances verified.

The connection capability is enabled across all the phases of the ConnectAlex programme which offers are made and/or loyalty awards are granted.

### ConnectAlex Reward System

ConnectAlex in utilising data obtained from participant organisation's distribution channels is enabled to implement a ConnectAlex Loyalty Systems across member organisations. The loyalty system is enabled in part rewards in the form of monitoring returns using the Digital Wallet, and one or more customer accounts of the business support system as enabled in 2(b) above.

### Go to Market Capabilities

The ConnectAlex wallet is enabled as a white label product for utilisation by one or more participant organisations.

Participant organisations are enabled to create new member product upon demand, so as to enable one or more new “Go to Market” (GTM) capabilities for the new or existing participant organisations (see discussion above under Distribution channel enhancement).

To recap, information captured by one participant organisation, such as at a retail point of sale, is enabled to be exchanged with other participant organisations so as, in turn, enable the same information to be used within one participant organisation to be used with other participant organisations. That is, one participant organisation can exchange customer data as a setup account within the ConnectAlex interface so accounts in other participant organisations products can be automatically generated with the customer's detail readily inserted. Likewise, the monitoring of account behaviours is enabled to be shared between participant organisations.

The distribution channel of one member organisation is enabled to provide the distribution channels for other member organisations. Likewise, ConnectAlex Loyalty Systems, a Digital Wallet and the “Go to Market” account generation enables allegiance to be formed between such collective organisations.

Instances Multiple ConnectAlex programs can be setup contiguously, to run in different products or for different geographies, or participants. Each separate ConnectAlex programme is generically known as an instance.

### Interconnected Swap System (ISS)

In still further embodiment, instances are enabled to incorporate an interconnected swap system (ISS) in the form of an inter-organisational interface with one or more finance provider(s) that are enabled to be switched on in tax necessary jurisdictions. The ISS can be switched on in those jurisdictions that seek to impose tax on any amounts held by a bank against liabilities of ConnectAlex account contingent or otherwise. The design of this is developed on a jurisdictional basis and is integral in managing the cash flows and liabilities to consumers and authorities.

### Digital Wallet

The ConnectAlex tool, method and system includes a Digital Wallet for the purpose of enabling the customer to make payments to one or more participant organisations or collectively to participant organisations, based upon which ConnectAlex programme the customer is involved.

The ConnectAlex tool, method and system's Digital Wallet acts as a transactional payment system that is enabled to be used to store financial data for online transactions via any computer enabled device including a PC or smartphone, whereas the ConnectAlex wallet is designed as a deposits wallet. That is, most wallets are designed as ‘payment’ wallets; however, the preferred embodiment has a ‘savings’ wallet functionality enabled.

In a further embodiment the ConnectAlex wallet is enabled with the features of:
a) providing a transactional savings wallet for customers;
b) recording payments made by customers to ConnectAlex programs in which they are involved;
c) Taking matching payments between participant organisations that are involved in a ConnectAlex program. For example, a customer may receive, via the generated offer, matching offers from participant organisations, so that if a customer deposits, for example, $5.00 into the ConnectAlex wallet, then the Telco will provide a matching offer of $5.00 as a data transfer to the customer account;
d) enabling the setup of sub-wallets or sub-accounts for specific deposits and goals, such as for a birthday present or holiday;
e) enabling portability across different ConnectAlex instances;
f) enabling the monitoring of the ‘score’ or value of the ConnectAlex wallets/accounts in the form of credits, which when authorised, is enabled to migrate these credit values between accounts of participant organisations. For example, the ConnectAlex wallet is enabled to transfer a $5.00 data transfer fee into bank deposit if and when the participatory FinCo account's specific criteria (both regulatory and internal) are met;
g) management of the ConnectAlex loyalty programme between participatory organisations such that when consumers have met certain criteria, the loyalty system can be redeemed, and
h) implementation of a reward system that manages and transfer rewards, loyalty schemes and bonus between participatory organisations for redeeming into offers matched.

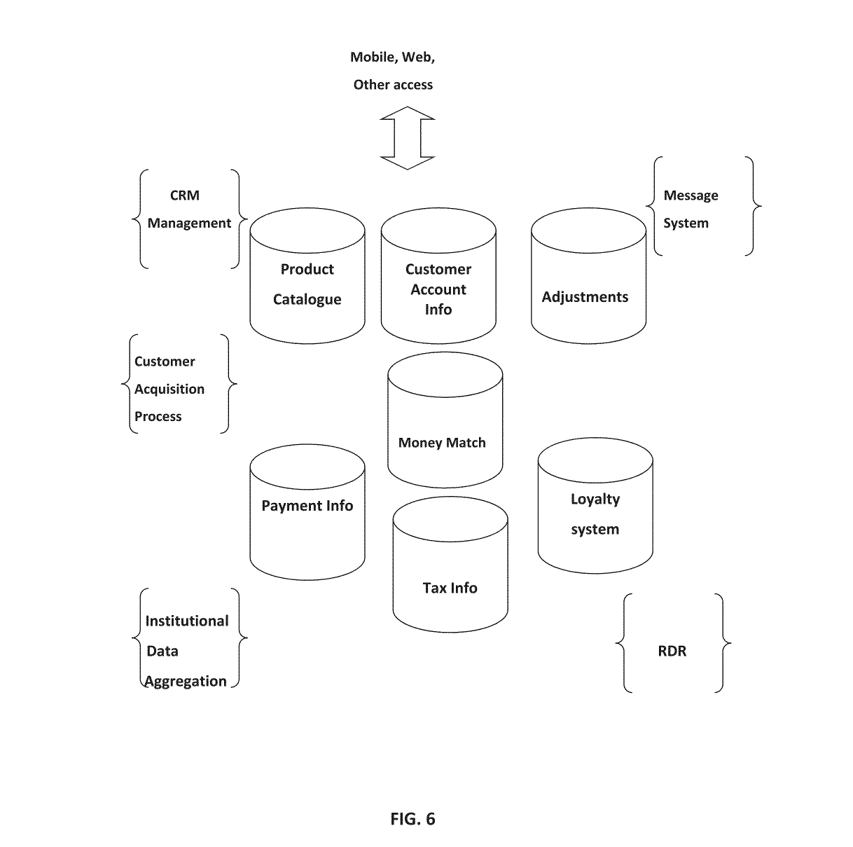

Referring to FIG. 6, inter-organisational interface has a billing functionality composed of a series of independent applications that, when run together, are referred to as the Billing System. The applications are:
a) Credit Control & Collection:—Controls usage and revenue by assigning different credit classes to different customers. Credits into the ConnectAlex wallet will be based upon the collections made by a participant organisation, for example, a Telco;
b) CRM (Customer Relationship Management)/OMOF (Order Management and Order Fulfilment) This application contacts with the billing system and billing system contacts with provisioning system to provision the services and network inventory system as well to assign phone numbers or IP addresses etc.
   Alternatively, the CRM/OMOF application, itself, contacts the provisioning system to provision the services and network inventory system as well to assign phone numbers or IP addresses etc.
c) Invoicing: This processes deposits, performs account administration, maintains tax and fee information and processes financial information. ConnectAlex will appear on a bill as a value-added service.
d) Order Management: Captures product and service orders, manages the order-entry life cycle and oversee the order-completion life cycle. ConnectAlex service is enabled to be setup as a service.
e) Participants and Sponsors Income Management: The sharing of revenue between Telcos and channels to market is managed by ConnectAlex applications such that ConnectAlex participants and sponsors are enabled to fund commissions to channel partners.
f) Problem Handling: Manages troubled-ticket entry, coordinates troubled-ticket closure, and tracks the resolution progress of a “trouble ticket”. Queries will be referred directly to ConnectAlex.

The provisioning system will pass data to ConnectAlex to setup membership and wallets.
g) Sales and Marketing: This application runs customer queries, handles commissions, provides sales support, tracks prospects, manages campaigns, analyses product performance.

### Business Processes

### Customer Acquisition Process

Customer Acquisition is the process of identifying, attracting and retaining potentially profitable customers. This is handled using a CRM system which is one of the important business support system (BSS).

A CRM system is enabled to be continuously connected with the ConnectAlex systems including Billing System (for example, in a Telco) and the Core Banking systems (for example, in a FinCo). The CRM system feeds customer personal data, product and service information.

A customer who is purchasing the products and/or services is enabled to be activated in the ConnectAlex system and method to obtain required customer details including the following steps:
a) lodgement of an application form providing personal detail will be performed by the customer;
b) validation of the lodged detail is performed to verify the identity of the customer in order to prevent fraud, for example via a participant TelCo and/or FinCo;
c) credit checks will be performed on the customer who lodged the application form;
d) assignment of an appropriate credit class based on credit history and monthly income etc. will be performed by the service provider;
e) offers will be made to the customer as aligned with their appropriate credit class;
f) management of the newly acquired customer will be performed including:
   i. Interacting and communicating with the customer for sales and collection activities;
   ii. Motivating customers to increase their deposits; and
   iii. Handling any disputes and adjustments raised.

When a customer joins a ConnectAlex program, they commit to deposit monies into the ConnectAlex wallet. The customer's in-store, web or call centre experience will be similar to their current experience.

For example, the use of the above ConnectAlex program involving a Telco and a FinCo, will involve:
a) a customer to make payments on a regular basis as a ConnectAlex deposit to a FinCo; and
b) a Telco, which adds an equivalent or other agreed amount to the customer's monthly invoice to match their ConnectAlex deposit.

The invoice payment will be matched to the ConnectAlex deposit amount so as to enable the Telco to have a matching contribution in terms of services delivered. These services will be invoiced and paid for by funds debited against the customer's ConnectAlex wallet. ConnectAlex systems will then notify FinCo systems that monies have been deposited and take the FinCo's matching deposit.

### FinCo Acquisition

For further example, an alternative scenario is operational when a ConnectAlex customer is acquired through the FinCo distribution channel. During Setup the FinCo Operational Support Systems (OSS) and Business Support Systems (BSS) are linked to ConnectAlex systems. These include the OSS Account Setup and Core Banking systems and their components. The core elements that are undertaken are:
a) FinCo Account Setup
b) capture of proof of identity as required by authorities within each jurisdiction and storage of support collateral
c) setup of ConnectAlex wallet
d) commitment to the ConnectAlex programme
e) phone Plan Setup (Provisioned)

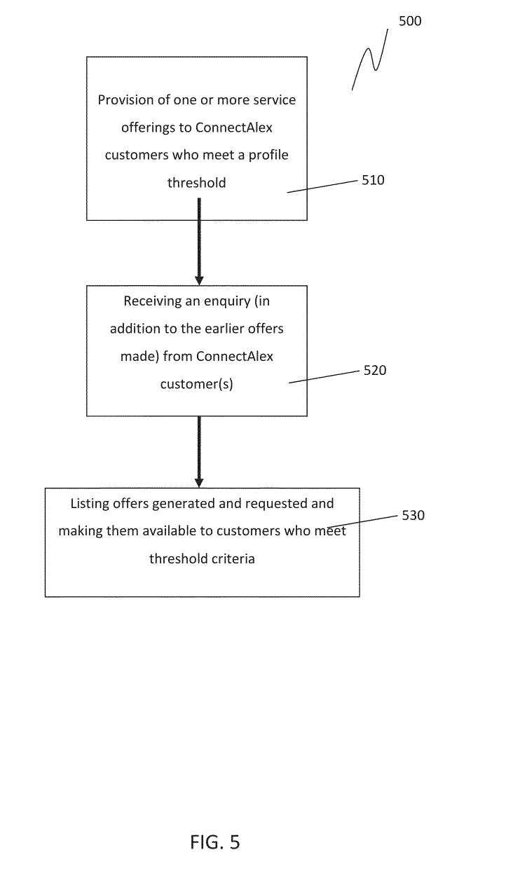

FIG. 5 is a flowchart of the inter-organisational offering process, which includes the following sub-steps:
a) provision of one or more service offerings to ConnectAlex customers who meet a profile threshold or criterion of the actuarially based algorithm that refines, directs and recommends outputs via the RDR system (step 510);
b) receiving an enquiry from one or more customers (in addition to the earlier offers made) and adding that request to the actuarially based algorithm that refines, directs and recommends offers (step 520) so that future requests will be potentially automatically satisfied;
c) listing offers generated and requested and making them available to customers who meet threshold criteria (step 530), wherein one or more offers are match as meeting specific needs of the consumer.

This offering process has an advantage over traditional customer offers and loyalty scheme models by using “data insights”:

“data insights” are generated by utilising the data independently collected from individual customers by each participant organisation, so that when these separate customer data sources are combined, there is an increased insight into the customer's profile through independent verification of data. This “data insight” improves the overall efficiency and reliability of the process of selecting relevant offers to customers.

All offers to be made to a customer are initially reviewed to remove such offers which are not relevant or appropriate the specific customer concerned.

This inter-organisational offering process involves further steps than are usually performed by any other current customer offers and loyalty scheme business model. However, the additional “data insights” assist to improve overall efficiency and effectiveness of the participant customers secured by reducing time wasted in making inappropriate offers or indeed failing to understand the customer's needs (or perceived needs) before making presenting an offer.

### ConnectAlex Loyalty System

The ConnectAlex loyalty system includes, but is non-exhaustive, the following components as discussed following this list:
a) Money Match
b) Good Deposits/Bad Deposits
c) Positive Re-enforcement
d) Minimum Commitment Period
e) Real Currency, not Points
f) Bonus currency
g) Wallet Scoring and migration to FinCo accounts
h) Deposits to other accounts

### Money Match

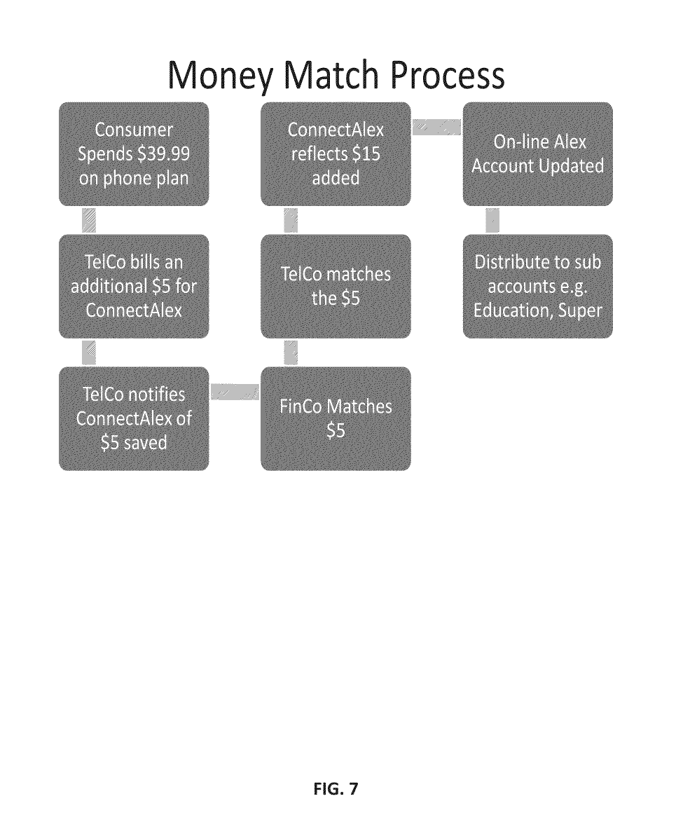

Referring to FIG. 7, there is a “Money Match Process” incorporated into ConnectAlex which enables exchanges of money or credits to take the following form:
a) when a customer saves deposits into their ConnectAlex wallet; then
b) other ConnectAlex participants are also enabled contribute and deposit monies into the same ConnectAlex wallet.

For example, when a customer deposits $5 per month into their wallet, then both TelCo and FinCo are also enabled deposit monies into the ConnectAlex wallet. If they match exactly the same amount, then they will both add $5. At the end of the first month the total contribution will be $15, $30 in the second month and $210 after 12 months. The amounts may vary based on product definition.

### Good Deposits/Bad Deposits

Allied with Money Match is that there is a concept of Good and Bad deposits. Good deposits are enabled to be ‘allowed’ to take Money Match funds, whereas Bad Deposits are excluded from making such deposits. The ConnectAlex charter is to help customers adhere a long term savings plan. Therefore, deposits that are aligned to this goal will be treated differently to short term goals. The amounts may vary based on product definition.

For example, a house deposit, an education fund or a superannuation account are all long term savings that are likely to improve a ConnectAlex customer's financial security and is considered a “Good” deposit. Customers will be able to channel Money Match deposits from FinCo and TelCo to support good deposits.

Bad money in the form of bad deposits is typically manifested as a short term savings goal, such as a holiday or a new car. In both cases, ConnectAlex will assist the customer in meeting their goals, but no Money Match deposits will be channelled into those accounts.

| Good deposits | Bad deposits |
|---|---|
| House Deposit | Holiday |
| Superannuation Fund | Car |
| Education | |

Account sponsors are enabled to market the right product to ensure that long term savings adherence is achieved e.g. a customer with a ‘holiday’ account may be offered travel insurance and not the matching dollars that the superannuation account.

### Positive Re-Enforcement Loops

In order to maximise savings a series of positive re-enforcement systems are included in ConnectAlex. These include targets for savings, by value saved and consistent top-up behaviour.

These positive re-enforcement systems are enabled to be displayed via the ConnectAlex interface be available on any network computer enabled application including computers and mobile phones. Prompting will be delivered via SMS and/or other messaging systems such that the ConnectAlex interface encourages ‘good behaviour’.

For example, the ConnectAlex provides sponsors, such as FinCos and Telcos the means of providing incentives as cash or other as behaviour re-enforcing mechanisms.

Examples include:
a) a bonus for meeting a savings target;
b) a bonus at the end of a contract; and/or
c) receiving exclusive ConnectAlex membership benefits and discounts.

The ConnectAlex interface provides a traffic light guide in the form of a Colour-Action guide with recommendations as follows:

Red Not reaching or setting savings goals. Recommend increasing savings events, setting targets, increasing savings rate
Amber Making progress to savings goals. Recommend increasing savings events, setting targets, increasing savings rate

### Green Reaching Savings Goals

### Minimum Commitment Period

ConnectAlex, in one embodiment and for example, is a long term savings programme also referred to as an accelerated loyalty and earnings maximiser programme, aimed to leverage the time-effect of money via the Money Match arrangements described above. ConnectAlex also aims to educate the customer on the benefits of saving, enabling the benefits to be embedded as a long-term behaviour pattern. Its functionality educates the consumer on the benefits of saving using positive reinforcement techniques.

For example, access to ConnectAlex Good Account wallets will be strictly monitored with a minimum of three (3) years before monies (via customers or ConnectAlex partners/participants) can be withdrawn. In contrast, monies in Bad Account wallets will be accessible after 6 months.

ConnectAlex is enabled to comply with any ‘cooling-off periods’ as legislated within the jurisdiction of operation of ConnectAlex. In the event that a customer does not wish to participate in ConnectAlex, then they will be repaid their monies, excluding the Money Match contributions from Participants and Partners.

### Real Money, not Points

Loyalty programmes and systems offer points or virtual currency as a means of rewarding the customers' behaviour. ConnectAlex is different as wallets are enabled to reflect real money as opposed to points. That is, any points are capable of being turned to pecuniary account as the wallets reflect monetary entitlement, not points. This can reflect the customers' deposits and the deposits of matchmaking participant's contributions. For example, those contributions made by a TelCo, FinCo and/or other ConnectAlex partners are reflected in addition to the customers' deposits.

### Bonus Currency

The programme participants can deposit bonus currency into ConnectAlex wallets based on criteria such as adding additional services, extending participation period, meeting and overachieving on savings goals.

A switch in the ConnectAlex interface enables consumers (and participants) to make additional payments to a specified ConnectAlex digital wallet. These additional payments are recorded in ConnectAlex wallets based on criteria such as adding additional services, extending participation periods, meeting or overachieving on savings goals.

For example, the ConnectAlex customers who have described to a ConnectAlex participant Telco service agreement may be enabled, via their four year contract, to receive two phones. For a further fee, this consumer becomes entitled to extra handsets on the same ConnectAlex service. This Arrangement is referred to as Morephones by ConnectAlex

### Wallet Scoring and Migration to FinCo Accounts

ConnectAlex customers are educated by the interface to be more aware of the power of savings, so it envisaged that they will become more valuable to, for example, a participant FinCo organisation for the provision of other services such as funds management and/or house mortgages.

ConnectAlex by the data enhancement is enabled to monitor such behaviours and ‘score’ their appropriateness using its proprietary algorithm. A high score enables a FinCo account is setup and a relevant person to person contact to be arranged. As proof of identity was originally setup when the ConnectAlex account was created, then the next step will be automated, with the proof also automatically sent to the FinCo's collateral systems.

### Gift Deposits to Other Accounts

In a typical setup the relationships between a ConnectAlex wallet and a mobile phone service will be one to one (1:1).

In a further embodiment, a ConnectAlex wallet can have multiple relationship and deposit inputs. For example, the wallet contents can pass through one wallet to another, as a Gift for the term of the program—this may be typically a gift from a parent or grandparent for the purposes of setting up an education fund.

### Benefits

An advantage of the preferred embodiment is that it empowers collegial organisations to:
a) implement an interface to quickly and efficiently analyse consumer need through using “data insight”;
b) analyse “data insights” to form bundled offers, where the offers made are potentially disruptive in the market due to greater data insight provided at lower cost, followed by
c) putting one or more offers to one or more customers who meet the criteria to receive such offers, and are identified as having a need as determined using “data insights”.

In an embodiment, there is provided a system for facilitating financial transactions including:
a) an inter-organisational connectivity method, system and device called ConnectAlex;
b) further steps in a method for generating one or more offers to meet consumer perceived or real needs as highlighted through the analysis of the data inputs from each participant organisation leading to the “data insights”;
c) review of the offers as generated to ensure that the opportunity cost to the benefit obtained be at least a “not for loss” or a profit to each cost centre for which the offer is delivered from, along with an assessment of the loyalty obtained from customers to the participant organisation(s); and
d) an inter-organisational offering method for selecting relevant offers to address identified customer real or perceived needs, wherein the inter-organisational offering meets customer needs.

An interface for providing inter-organisational offers is enabled to:
a) dynamically and effectively adapt to respond to one or more customer's perceived needs in both the near-term and far term;
b) have independent responsibility and authority in defined area, since large organisations have traditionally been limited in being able to act in dynamic manner collectively whilst managing the responsibility for the delivery of their goods/services; and
c) dynamically generate offers to meet customer's real or perceived needs; and
d) facilitate the efficient delivery of perceived value to the customer, as derived from data exchanged between participant organisations.

The invention provides a method, system and tool to implement an inter-organisational interface for use by customers and the participant organisations. However, it will be appreciated that the invention is not restricted to these particular fields of use and that it is not limited to particular embodiments or applications described herein.

Comprises/comprising when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to.

I claim:

1. A computer program product embodied in a computer readable storage medium for generation of one or more offers to match analysis of customer need (GOMAC), the computer program product comprising programming instructions for:
a) analysis of a customer need;
b) review of an organisation's offers;
c) matching of said offers to said analysis of customer need;
d) identification of said customer need not met by said organisation's offers;
e) generation of one or more new offers to match said analysis of customer need (GOMAC) not previously met by an organisation's offers; and
f) presentation of said GOMAC to one or more customers.

2. The computer program product of claim 1 wherein the organisation's offers include inter-organisational generated offers made by two or more participant organisations, wherein the participant organisations include one or a combination of the following:
a) an organisation known to a customer;
b) an organisation not previously known to the customer.

3. The computer program product of claim 1 wherein the presentation of said GOMAC to one or more customers is reported via a GOMAC interface.

4. The computer program product of claim 3 wherein the GOMAC interface enables a customer to accept said GOMAC.

5. The computer program product of claim 4 wherein the GOMAC interface further enables a transfer of funds after acceptance of said GOMAC.

6. The computer program product of claim 5 wherein said transfer of funds utilises a digital wallet via the GOMAC interface to perform one or more of the following:
a) provide a transactional record of:
i. customer's payment of fees due;
ii. receipt of a refund;
iii. payment of one or more instalments due;
iv. calculation of payments due or owed; or
b) distribute funds relating to the GOMAC;
c) matching transactions between parties; and
d) management of a reward system.

7. The computer program product of claim 1 wherein said GOMAC interface assesses customer need by analysing one or more of the following:
(a) previous customer purchasing criteria,
(b) behaviours; or
(c) associated customer data, wherein associated customer data includes one or more of:
i. demographic data;
ii. harvested data; or
iii. customer declared preferences;
iv. customer provided data.

8. The computer program product of claim 1 wherein said GOMAC interface is enabled to perform one or more of the following:
a) connect a plurality of participant organisations together;
b) integrate participant organisations' data;
c) data map between organisations to ensure the integrity of the data;
d) form a synergistic dataset from data contributions of one or more participant organisations;
e) analyse one or more of the following:
i. each participant organisation's data; and
ii. the collective participant organisations' synergistic dataset, to provide customer data profiles that specify the customer need;
f) refine one or more GOMACs suitable for one or more specific customers;
g) confirm the validity ofa GOMAC with one or more participant organisations;
h) report GOMACs to said one or more specific customers who meet a suitability threshold to receive said GOMACs; and
i) educate the customer through presentation of one or more GOMACs via a Business to Customer Education system to reveal the benefits of a GOMAC over existing goods or services.

9. The computer program product of claim 1 wherein said GOMAC interface is further enabled to perform one or more of the following:
a) exchange of data concerning customers between participant organisations;
b) allowing of participant organisations to individually or collectively execute a GOMAC;
c) generation of a cost and benefit analysis to each participant organisation from the GOMACs; and or
d) offering to customers one or more GOMACs in a “mixed and matched” manner so as to meet customer need.

10. A computer program method for generation of one or more offers to match analysis of customer need (GOMAC), the method being performed by a processor and including the steps of:
(a) analysis of a customer need;
(b) review of an organisation's offers;
(c) matching of said offers to said analysis of customer need;
(d) identification of said customer need not met by said organisation's offers;
(e) generation of one or more new offers to match said analysis of customer need (GOMAC) not previously met by an organisation's offers; and
(f) presentation of said GOMAC to one or more customers.

11. The computer program method of claim 10 wherein the organisation's offers include inter-organisational generated offers made by two or more participant organisations, wherein the participant organisations include one or a combination of the following:
a) an organisation known to a customer;
b) an organisation not previously known to the customer.

12. The computer program method of claim 10 wherein the presentation of said GOMAC to one or more customers is reported via a GOMAC interface.

13. The computer program method of claim 12 wherein the GOMAC interface enables a customer to accept said GOMAC.

14. The computer program method of claim 13 wherein the GOMAC interface further enables a transfer of funds after acceptance of said GOMAC.

15. The computer program method of claim 14 wherein said transfer of funds utilises a digital wallet via the GOMAC interface to perform one or more of the following:
a) provide a transactional record of:
i. customer's payment of fees due;
ii. receipt of a refund;
iii. payment of one or more instalments due;
iv. calculation of payments due or owed; or
b) distribute funds relating to the GOMAC;
c) matching transactions between parties; and
d) management of a reward system.

16. The computer program method of claim 10 wherein said GOMAC interface assesses customer need by analysing one or more of the following:
(a) previous customer purchasing criteria,
(b) behaviours; or
(c) associated customer data,
wherein associated customer data includes one or more of:
i. demographic data;
ii. harvested data;
iii. customer declared preferences; or
iv. customer provided data.

17. The computer program method of claim 10 wherein said GOMAC interface is enabled to perform one or more of the following:
a) connect a plurality of participant organisations together;
b) integrate participant organisations' data;
c) data map between organisations to ensure the integrity of the data;
d) form a synergistic dataset from data contributions of one or more participant organisations;
e) analyse one or more of the following:
i. each participant organisation's data; and
ii. the collective participant organisations' synergistic dataset, to provide customer data profiles that specify the customer need;
f) refine one or more GOMACs suitable for one or more specific customers;
g) confirm the validity of a GOMAC with one or more participant organisations;
h) report GOMACs to said one or more specific customers who meet a suitability threshold to receive said GOMACs; and
i) educate the customer through presentation of one or more GOMACs via a Business to Customer Education system to reveal the benefits of a GOMAC over existing goods or services.

18. The computer program method of claim 10 wherein said GOMAC interface is further enabled to perform one or more of the following:
a) exchange of data concerning customers between participant organisations;
b) allowing of participant organisations to individually or collectively execute a GOMAC;
c) generation of a cost and benefit analysis to each participant organisation from the GOMACs; and
d) offering to customers one or more GOMACs in a “mixed and matched” manner so as to meet customer need.

19. A system for generation of one or more offers to match analysis of customer need (GOMAC) including:
(a) the computer program product of claim 1; and
(b) a computer program method for implementing the programming instructions of the computer program product.
